(19) United States
(12) Patent Application Publication
(10) Pub. No.: US 2005/0141895 A1
(43) Pub. Date: Jun. 30, 2005

(54) Isolating radio frequency components of a wireless device

(76) Inventor: Everardo D. Ruiz, Beaverton, OR (US)

Correspondence Address: TROP PRUNER & HU, PC, 8554 KATY FREEWAY, SUITE 100, HOUSTON, TX, 77024, US

(21) Appl. No.: 10/751,082

(22) Filed: Dec. 31, 2003

(51) Int. Cl. H04B 10/00

(52) U.S. Cl. 398/115

(57) ABSTRACT

Radio frequency components may be optically isolated from lower frequency components of a transceiver to improve the sensitivity and transmission efficiency in some embodiments. In one embodiment, an optical waveguide may be utilized to isolate the low noise amplifier from other components downstream in the received path. Similarly, an optical waveguide may be utilized to isolate lower frequency components from a downstream radio frequency power amplifier.

### BACKGROUND

This invention relates generally to wireless communications.

Wireless communications may be implemented by transceivers that are capable of both transmission and reception of wireless signals. Wireless signals may be a variety of types, including those for short range radio communications on the order of 10 meters, longer range radio communications between processor-based systems and peripherals, and cellular communications, to mention a few examples.

Generally, the radio frequency components of such systems tend to adversely affect the other components of these systems or of similar systems located near by. For example, the radio frequency components may adversely affect other components that operate at intermediate frequencies (IF) and baseband frequencies or very low IF. The effect of exposure of these more sensitive components to the radio frequency components may include reduced receiver sensitivity and transmitter power efficiency or interference with other neighboring radios.

Thus, there is a need for alternate ways to implement radios.

### BRIEF DESCRIPTION OF THE DRAWINGS

FIG. 1 is a block depiction of a transmitter in accordance with one embodiment of the present invention;

FIG. 2 is a block depiction of a receiver in accordance with one embodiment of the present invention;

FIG. 3 is a schematic depiction of a processor-based system that may utilize the components illustrated in FIGS. 1 and 2 in accordance with one embodiment of the present invention;

FIG. 4 is a physical depiction of a transmitter in accordance with one embodiment of the present invention; and

FIG. 5 is a physical depiction of a receiver in accordance with one embodiment of the present invention.

### DETAILED DESCRIPTION

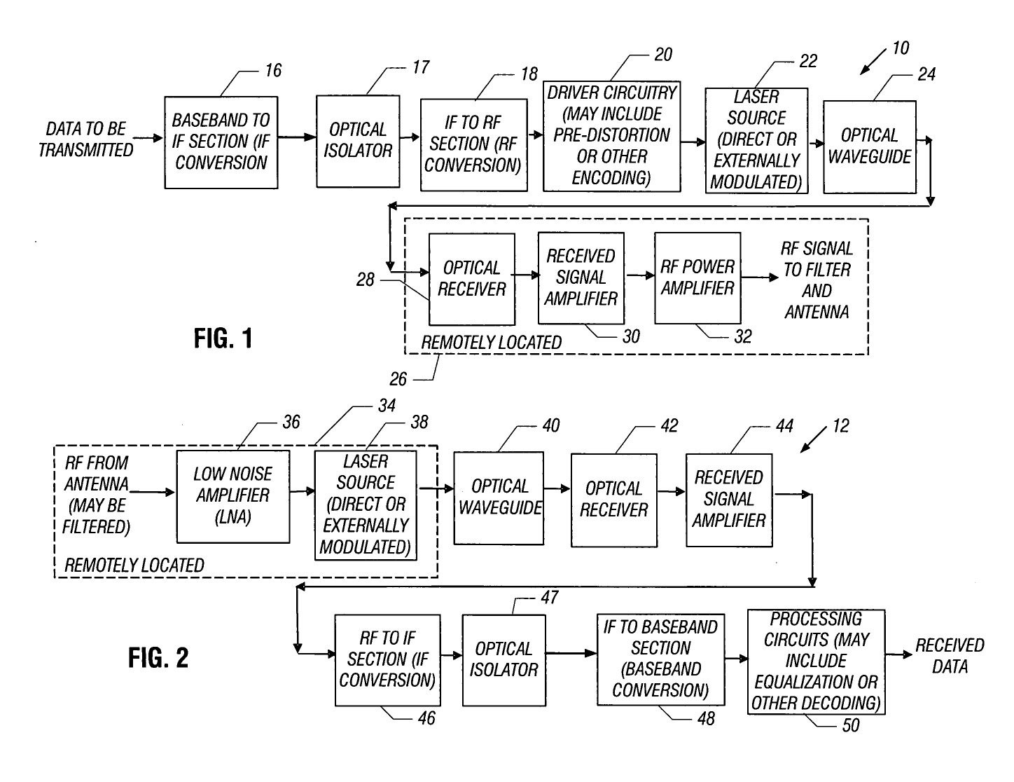

Referring to FIG. 1, data to be transmitted by a transceiver may be received by a baseband to intermediate frequency section 16 that is responsible for converting the data to an intermediate frequency. The intermediate frequency data may then be converted to radio frequency in a section 18. The conversion to radio frequency may also be direct via one baseband-to-radio frequency conversion. Also, an optical isolator 17 may be provided between sections 16 and 18 in some embodiments. The radio frequency signal is passed through driver circuitry 20 that may include pre-distortion or other encoding.

The driver circuitry 20 may drive a laser source 22. The laser source 22 may be directly or externally modulated as two examples. The laser signal now containing the information to be transmitted wirelessly, is then transmitted over an optical waveguide 24 to an optical receiver 28. The received signal is amplified in a signal amplifier 30 and provided to a radio frequency power amplifier 32. The amplifier 32 may be coupled to a filter and an antenna, such as a dipole antenna or other suitable antenna.

Thus, it may be appreciated that the radio frequency power amplifier is optically isolated from the intermediate frequency or lower frequency components of the transmitter 10. The radio frequency power amplifier 32, through the imposition of the optical waveguide 24, may be remotely located from the other more sensitive components 26, 16, or 18.

Referring to FIG. 2, a receiver may include a radio frequency section 34 which may be remotely located from the rest of the receiver 12. The radio frequency signal from an antenna (which may be filtered) is provided to a low noise amplifier 36. The amplifier 36 provides information to a laser source 38 which, again, may be directly or externally modulated, to mention two examples. The laser source 38 may then drive a laser signal over an optical waveguide 40 to an optical receiver 42.

A received signal amplifier 44 amplifies the received signal. The signal is then converted from radio frequency to intermediate frequency (IF) at block 46. The intermediate frequency may then be converted to a baseband frequency at block 48. Also, an optical isolator 47 may be included in some embodiments. The conversion from radio frequency to baseband (low IF or zero IF) may also be achieved in a single down conversion step using analog or digital techniques. Processing circuits 50 may include an equalizer or other decoding circuitry for processing the data that has been received. Again, it may be appreciated that the low noise amplifier 36 may be remotely located from more sensitive intermediate frequency and baseband frequency components.

In some embodiments, the radio frequency sections and other portions of the radio typically located near sensitive components may be provided remotely from those components. As a result, in some embodiments, receiver sensitivity may be improved. This improvement may be due to reduced radio frequency path loss from the antenna to the low noise amplifier 36 in the case of the receiver 12. Transmitter power efficiency may be improved, in some embodiments, because of the reduced path loss from the power amplifier 32 to the antenna. A radio transceiver including receiver 12 and transmitter 10 may be amenable to software upgrades to process intermediate frequency and baseband frequency radio signals in some embodiments.

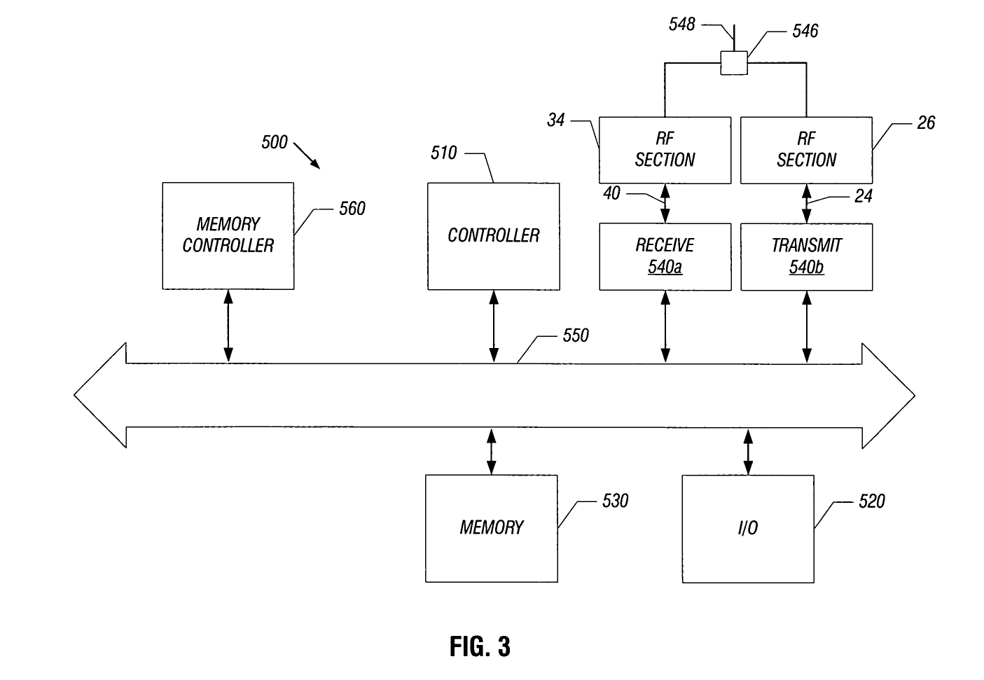

Referring to FIG. 3, a portion of a system 500, in accordance with one embodiment of the present invention, is illustrated. The system 500 may be used in a wireless device such as, for example, a personal digital assistant (PDA), a laptop or portable computer with wireless capability, a web tablet, a wireless telephone, a pager, an instant messaging device, a digital music player, a digital camera, a game console, a home entertainment center, or other devices that may be adapted to transmit and/or receive information wirelessly. The system 500 may be used in any of the following systems: a wireless local area network (WLAN) system, a wireless personal area network (WPAN) system, or a cellular network, although the scope of the present invention is not limited to these wireless systems.

The system 500 may include a controller 510, an input/output (I/O) device 520 (e.g., a keypad, display), a memory 530, and a wireless interface 540 coupled to each other by a bus 550 or directly connected with each other. It should be noted that the scope of the present invention is not limited to embodiments having any or all of these components.

The controller 510 may comprise, for example, one or more microprocessors, digital signal processors, microcontrollers, or the like. The memory 530 may be used to store messages transmitted to or by the system 500. The memory 530 may also optionally be used to store instructions that are executed by the device 510 during the operation of the system 500, and may be used to store user data. The memory 530 may be provided by one or more different types of memory. For example, the memory 530 may comprise a volatile memory (any type of random access memory), or a non-volatile memory, such as a FLASH memory.

The I/O device 520 may be used to generate a message. The system 500 may also use the receive section 540a and transmit section 540b to transmit and receive messages to and from a wireless communication network with a radio frequency signal. The receive section 540a may correspond to the components of the receiver 12, other than those remotely located components 36. The receive section 540a may be coupled over an optical waveguide 40 to an RF section 34, which corresponds to the remotely located section 34 in FIG. 2. The section 34 in turn may be coupled to a duplexer/triplexer 546, coupled to an antenna 548 (or to a multiplicity of filters and antennas).

The duplexer/triplexer 546 may also be coupled to the RF section 26 which is remotely located in FIG. 1. The RF section 26 may be coupled over an optical waveguide 24 to the transmit section 540b, which includes the components other than the remotely located components 26. Thus, it may be appreciated that the RF sections 26 and 34 may be isolated from the receive section 540a and the transmit section 540b.

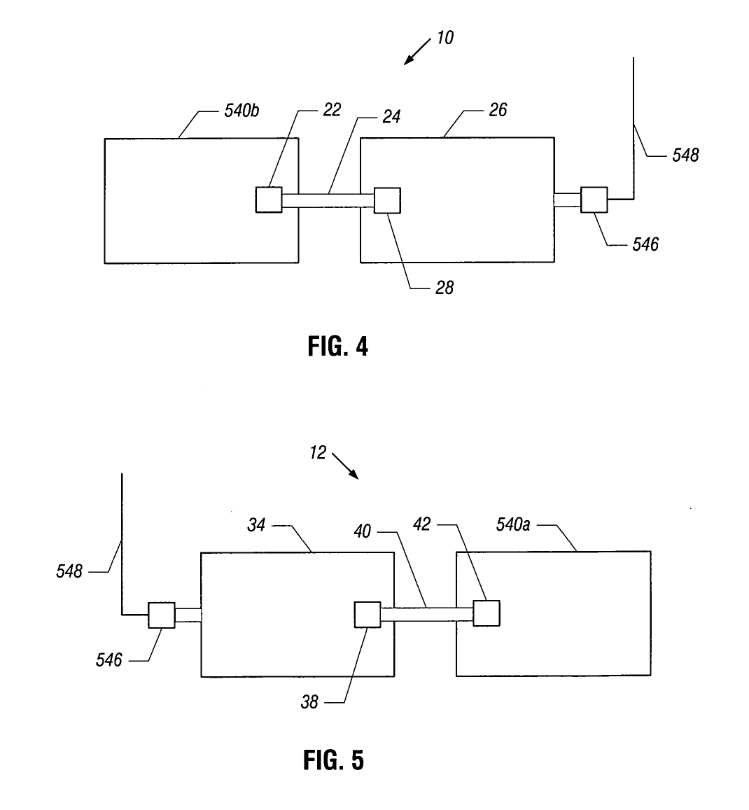

Referring to FIG. 4, the transmitter 10 may be implemented in one embodiment by two printed circuit boards, one being the transmit section 540b and the other being the RF section 26. Thus, the RF components may be on a separate printed circuit board from the rest of the transmit components. The two boards may then be coupled by an optical waveguide 24. The optical waveguide 24 receives its information from the laser source 22, which information is decoded on the RF section 26 by the optical receiver 28. The signal is eventually sent out through a duplexer/triplexer 546 and an antenna 548.

The waveguide 24 may be an optical fiber that couples the transmit section 540b and the RF section 26 in one embodiment of the present invention. The waveguide 24 may also be parallel optical fibers in another embodiment of the present invention. In another embodiment of the present invention, however, the waveguide 24 may be formed on a semiconductor chip by integrated circuit fabrication techniques. For example, a silicon nitride waveguide may be formed by conventional semiconductor fabrication techniques within an integrated circuit. In such case, a single integrated circuit could implement the waveguide 24, laser source 22, and the optical receiver 28 and one or more additional components in some embodiments of the present invention.

Referring to FIG. 5, the receiver 12 includes the antenna 548 and the duplexer or triplexer 546. A first circuit board may include the RF section 34 and a second circuit board may include the receive section 540a. An optical waveguide 40 again couples a laser source 38 to receiver 42. Again, the waveguide 40 may be an optical fiber in one embodiment of the present invention. In another embodiment, an integrated waveguide may be utilized which also includes other components including the laser source 38 and the receiver 42.

An optical isolator 17, including components 22, 24, and 26, may also be located between the elements 16 and 18 in another embodiment of the present invention. Likewise, an optical isolator 47, including components 38, 40, and 42, may be located between the elements 46 and 48 in another embodiment of the present invention. In these cases, an optical isolator 17 or 47 is used between frequency conversion stages, such as RF to IF and IF to baseband conversion stages, and vice versa.

While the present invention has been described with respect to a limited number of embodiments, those skilled in the art will appreciate numerous modifications and variations therefrom. It is intended that the appended claims cover all such modifications and variations as fall within the true spirit and scope of this present invention.

1. A method comprising:
optically isolating a radio frequency component from a lower frequency component of a transceiver.

2. The method of claim 1 including optically isolating a radio frequency power amplifier.

3. The method of claim 1 including optically isolating a low noise amplifier.

4. The method of claim 1 further including optically isolating frequency conversion stages.

5. The method of claim 1 including linking the radio frequency component and lower frequency component with an optical waveguide.

6. The method of claim 1 including converting a radio frequency signal to an optical signal using a laser.

7. The method of claim 1 including optically isolating the radio frequency component from a baseband component.

8. The method of claim 1 including optically isolating the radio frequency component from an intermediate frequency component.

9. A wireless device comprising:
a radio frequency component;
a lower frequency component to operate at a frequency lower than radio frequency; and
an optical link to link said components.

10. The device of claim 9 wherein said radio frequency component is a power amplifier.

11. The device of claim 9 wherein said radio frequency component is a low noise amplifier.

12. The device of claim 9 including a receiver.

13. The device of claim 9 including a transmitter.

14. The device of claim 9 including two frequency conversion stages and an optical isolator between said stages.

15. The device of claim 9 wherein said lower frequency component is a baseband component.

16. The device of claim 9 wherein said lower frequency component is an intermediate frequency component.

17. A system comprising:
a controller;
a radio frequency component;
a lower frequency component;
an optical link to link said components; and
a wireless interface coupled to said radio frequency component.

18. The system of claim 17 wherein said radio frequency component is a power amplifier.

19. The system of claim 17 wherein said radio frequency component is a low noise amplifier.

20. The system of claim 17 further including two frequency conversion stages and an optical isolator between said stages.

21. The system of claim 17 including a receiver.

22. The system of claim 17 including a transmitter.

23. The system of claim 17 wherein said lower frequency component is a baseband component.

24. The system of claim 17 wherein said lower frequency component is an intermediate frequency component.

25. The system of claim 17 wherein said wireless interface is a dipole antenna.
